(19) United States
(12) Patent Application Publication
(10) Pub. No.: US 2007/0271193 A1
(43) Pub. Date: Nov. 22, 2007

(54) BILLING AND ACCOUNT MANAGEMENT SYSTEM

(75) Inventor: Kenneth Tan, Balwyn North (AU)

Correspondence Address: KNOBBE MARTENS OLSON & BEAR LLP, 2040 MAIN STREET, FOURTEENTH FLOOR, IRVINE, CA, 92614, US

(73) Assignee: Mobileworld Communications Pty Ltd., South Melbourne (AU)

(21) Appl. No.: 11/615,744

(22) Filed: Dec. 22, 2006

(30) Foreign Application Priority Data
Dec. 23, 2005 (AU) 2005907303

(51) Int. Cl. G06Q 20/00

(52) U.S. Cl. 705/79

(57) ABSTRACT

A billing system, comprising a service provider account management system configured to maintain at least one service provider account for a customer, and a financial institution account management system configured to maintain at least one financial institution account for the customer, and a gateway in data communication with the service provider account management system and the financial institution account management system, configured to exchange account data between the service provider account management system and the financial institution account management system. The account data is adapted to allow the service provider account management system and the financial institution account management system to synchronize the service provider account and the financial institution account, and the service provider account management system and the financial institution account management system are arranged to update the service provider account and the financial institution account respectively according to the account data.

### RELATED APPLICATION

This application claims the benefit of Australian Application No. 2005907303, filed 23 Dec. 2005, the content of which is incorporated herein by reference in its entirety.

### FIELD OF THE INVENTION

The invention relates to a billing and account management system and method, of particular but by no means exclusive application in the provision of utilities such as telephony, mobile telephone services and other telecommunications services.

### BACKGROUND OF THE INVENTION

Some financial services institutions employ an approach where transactions feed into their account management systems which in turn feed into their account statement systems (similar to a billing application).

However, in these approaches there exists significant duplication of activities, systems and expenditure, as each service provider's billing approach requires similar components and infrastructure as other service provider billing processes (and evident from the level of duplication).

In addition, bill payment occurs across organisational boundaries. Multiple crossing of organisational boundaries for financial transactions provides multiple points of attack for hackers and other malicious parties, requiring significant IT expenditure on VPNs (virtual private networks) and the like to prevent this.

### SUMMARY OF THE INVENTION

An embodiment provides a billing system. The billing system of this embodiment includes a service provider account management system configured to maintain at least one service provider account for a customer, and a financial institution account management system configured to maintain at least one financial institution account for said customer. The billing system further includes a gateway in data communication with the service provider account management system and the financial institution account management system. The gateway is configured to exchange account data between the service provider account management system and the financial institution account management system. The account data is adapted to allow the service provider account management system and the financial institution account management system to synchronize the service provider account and the financial institution account, and the service provider account management system and the financial institution account management system are arranged to update the service provider account and the financial institution account respectively according to the account data.

Another embodiment provides a billing system. The billing system of this embodiment includes a service provider account management system configured to receive data indicative of a service provision to a customer, to determine a charge corresponding to said service provision, to output billing data indicative of the customer and of the charge, and to maintain at least one service provider account for the customer. The billing system further includes a gateway in data communication with the service provider account management system, configured to receive the billing data, to prepare service provider account data from the billing data, and to direct the service provider account data to a financial institution account management system. The gateway is operable to be in electronic data communication with the financial institution account management system, the service provider account data is adapted to be receivable by the financial institution account management system and to control or prompt the financial institution account management system to modify at least one financial institution account of the customer to include information indicative of the charge. The service provider account management system is adapted to receive financial institution account data from the financial institution account management system indicative of deposits to or withdrawals from the financial institution account, so that the financial institution account and the service provider account can be synchronized, whereby the customer can ascertain information about the service provider account by inspecting the financial institution account.

Another embodiment provides a billing interface system. The billing interface system of this embodiment includes a financial institution account database containing at least one financial institution account of a customer, and a financial institution account management system. The financial institution account management system is configured to maintain the financial institution account, to receive account data relating to the customer from at least one service provider and to respond thereto by modifying said financial institution account to reflect the account data, such that the financial institution account is synchronized with at least one corresponding service provider account maintained by the service provider, so that the customer can ascertain information about the service provider account by inspecting the financial institution account.

Another embodiment provides a method of managing at least one service provider account of a customer. The method of this embodiment includes maintaining the service provider account with a service provider account management system, and maintaining at least one financial institution account with a financial institution account management system. The method further includes electronically synchronizing the service provider account and the financial institution account by electronically exchanging account data between the service provider account management system and the financial institution account.

Another embodiment provides a billing or accounting system. The system of this embodiment includes a first vendor account management system configured to maintain at least one first vendor account for the customer, and a second vendor account management system configured to maintain at least one second vendor account for the customer. The system further includes a gateway in data communication with the first vendor account management system and the second vendor account management system, configured to exchange account data between the first vendor account management system and the second vendor account management system. The account data is adapted to allow the first vendor account management system and the second vendor account management system to synchronize the first vendor account and the second vendor account, and the first vendor account management system and the second vendor account management system are arranged to update the first vendor account and the second vendor account respectively according to the account data.

Another embodiment provides an account data packet or packets. The data packet or packets of this embodiment are adapted to control or prompt an account management system of a financial institution to modify at least one account of a customer to reflect a charge derived from data indicative of a service provision, so that said financial institution account can mirror at least one corresponding service provider account.

Another embodiment provides an account data packet or packets adapted to control or prompt an account management system of a first service provider to modify at least one account of a customer to be synchronized to a second service provider.

### BRIEF DESCRIPTION OF THE DRAWINGS

In order that the invention may be more clearly ascertained, embodiments will now be described, by way of example, with reference to the accompanying drawing, in which:

FIG. 1 is a schematic diagram of a bill presentment and payment system;

FIG. 2 is a schematic diagram of a billing system according to an embodiment;

FIG. 3 is a schematic diagram of an example of the billing system of FIG. 2 in use for activating a mobile telephony account at a bank;

FIG. 4 is a view of the user interface of the billing system of FIG. 2; and

FIG. 5 is a flowchart of real-time user customer call usage measurement according to the billing system of FIG. 2.

### DETAILED DESCRIPTION OF THE INVENTION

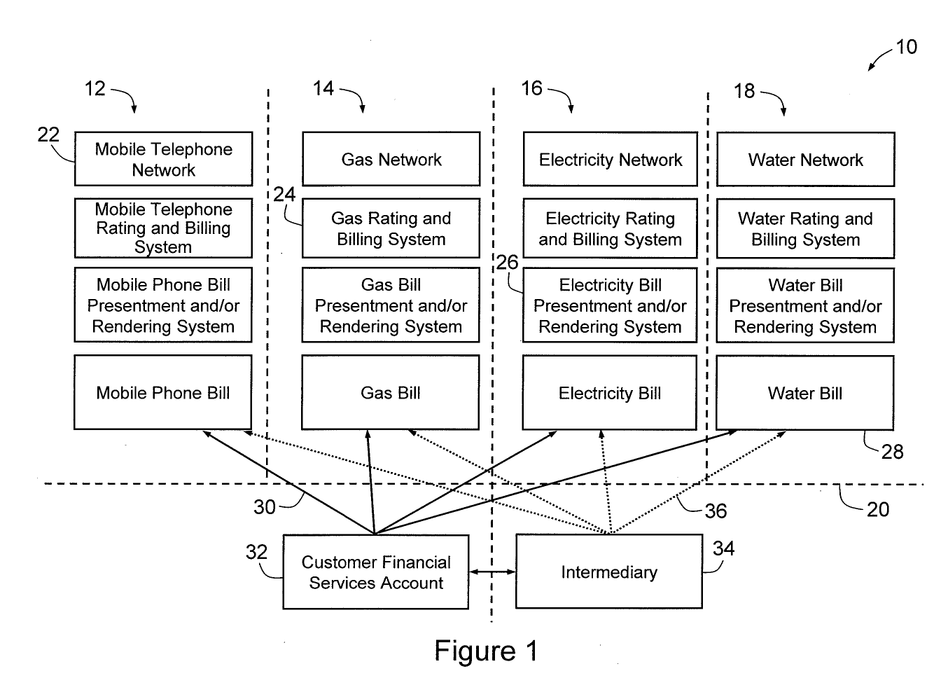

A number of billing systems consolidate the process by which customers receive and can pay their bills. In one existing system, each service provider uses a vertically integrated billing approach. A service provider (whether of telecommunications, gas, electricity or otherwise) polls its own network to generate transaction records. These records are rated by the application of unit pricing and discounting, then passed to a bill presentation application. The presentation application employs one or more communications channels (whether mail, internet or telephone), by means of which the customer receives and settles their bill. The customer may in some cases employ more than one of these channels, such as receiving a paper bill by mail, but settling that bill on the internet. FIG. 1 is a schematic representation 10 of this approach of the background art. In FIG. 1, each of a plurality of systems 12, 14, 16, 18 are separately operated, each vertically integrated by industry. In this figure, organizational boundaries 20 are indicated by a grid of dashed lines.

In the example of FIG. 1, first system 12 relates to mobile telephony, second system 14 to a gas utility, third system 16 to an electricity utility and fourth system 18 to a water utility. Each of systems 12, 14, 16, 18 includes subsystems including the system that physical provides the respective utility (e.g. Mobile Phone Network 22), a billing subsystem (e.g. Gas Rating and Billing System 24), and a bill presentment subsystem (e.g. Electricity Bill Presentment and/or Rendering System 26). These subsystems are in data communication with each other (though only within each vertically integrated industry), so that the ultimate bill (e.g. water bill 28) can be generated. The customer then pays the bill by transferring funds 30 from a financial services account 32 (such as a savings account or credit card account) to the nominated account of the relevant service provider (such as the mobile telephony provider). This process—which also crosses organisational boundaries 20—may optionally involve an intermediary 34 (such BPAY, VISA, AMEX or Mastercard brand financial service providers); the systems 12, 14, 16, 18 communicate their bills to the customer via that intermediary 34, and the customer settles the bill by interacting with the intermediary 34. The intermediary 34 then forwards 36 the necessary funds to respective system 12, 14, 16, 18.

An example of the system employed by an intermediary such as intermediary 34 is disclosed in International/PCT Publication No. WO 97/16798 A1 published on May 9, 1997 in the name of Mastercard International Inc., which is incorporated by reference in its entirety. That document discloses a bill delivery and payment system whereby a user—typically using a personal computer—accesses the intermediary's server computer (such as via the internet) to obtain and view bill information (or receives that information by email), and pays bills by suitably instructing the server computer (or by replying to email).

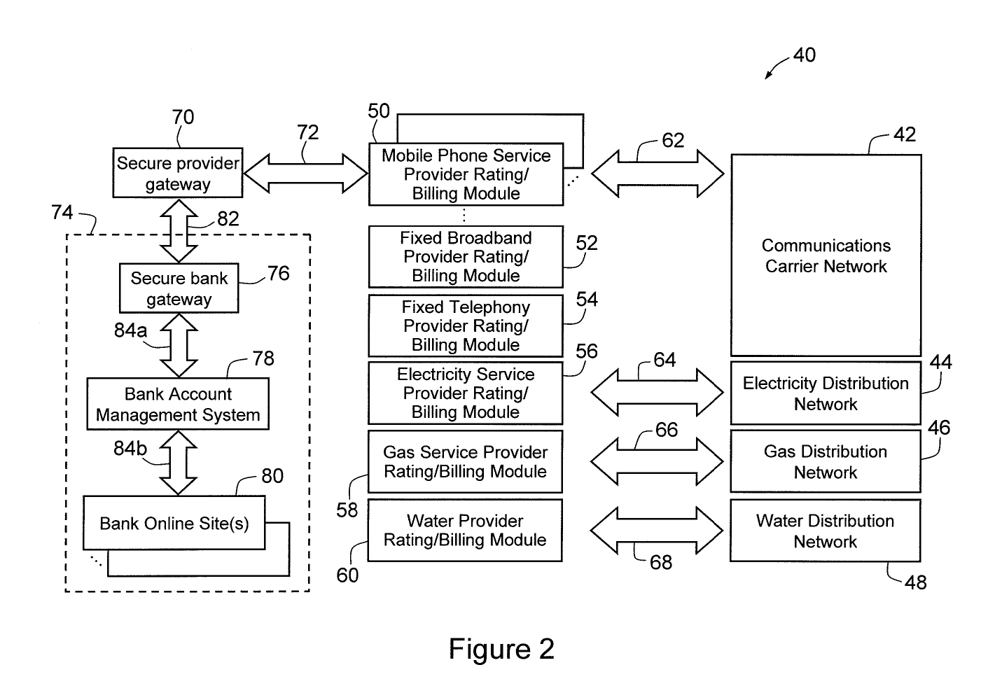

A billing system according to an embodiment is shown generally at 40 in FIG. 2 in use with a plurality of utility networks (in the form of, in this example, a communications carrier network 42, an electricity distribution network 44, a gas distribution network 46 and a water distribution network 48). It should be understood that any one of utility networks 42, 44, 46, 48 may itself comprise a plurality of separate networks of like type.

The system 40 includes a plurality of rating and billing modules, each of a respective service provider corresponding to a respective utility; system 40 includes Mobile Phone Service Provider rating and billing module 50, Fixed Broadband Provider rating and billing module 52, Fixed Telephony Provider rating and billing module 54, Electricity Service Provider rating and billing module 56, Gas Service Provider rating and billing module 58 and Water Provider rating and billing module 60. It will be appreciated that a particular service provider may also provide the corresponding utility network. For example, the mobile telephone service provider that operates Mobile Phone Service Provider rating and billing module 50 will commonly be a different entity from the provider of the communications carrier network 42, but in some cases they may be the same entity.

The system 40 also includes a plurality of data communications links 62, 64, 66, 68 of known type arranged to provide real-time exchange of activity and usage information between utility networks 42, 44, 46, 48 and rating and billing modules 50, 52, 54, 56, 58, 60. In this example, data communications link 62 provides data communications between communications carrier network 42 and Mobile Phone Service Provider rating and billing module 50, Fixed Broadband Provider rating and billing module 52 and Fixed Telephony Provider rating and billing module 54. Data communications link 64 provides data communications between electricity distribution network 44 and Electricity Service Provider rating and billing module 56. Data communications link 66 provides data communications between gas distribution network 46 and Gas Service Provider rating and billing module 58, while data communications link 68 provides data communications between water distribution network 48 and Water Provider rating and billing module 60.

The system 40 includes, for each of rating and billing modules 50, 52, 54, 56, 58, 60, a secure provider gateway; an exemplary secure provider gateway 70 is shown in FIG. 2 in data communication with Mobile Phone Service Provider rating and billing module 50 via data link 72. It will be appreciated, however, that system 40 includes further secure provider gateways for the other rating and billing modules 52, 54, 56, 58, 60, and the following description of exemplary secure provider gateway 70 applies equally to those other secure provider gateways. Secure provider gateway 70 is a computer arranged to perform aggregation, parsing, data integration and formatting of billing data output by Mobile Phone Service Provider rating and billing module 50 and received via data link 72. The output of secure provider gateway 72 is thus ready for forwarding to a financial institution (such as a bank), as is discussed below. It will be appreciated, however, that the data processing functions of the secure provider gateway 70 could in other embodiments be performed by a bank-side gateway, or that the gateway could comprise two components: a data processing component and a communications component.

In FIG. 2, a financial institution in the form of a bank is depicted schematically at 74. It will be appreciated by those in the art that, although this embodiment refers to a single financial institution and hence includes only a single bank 74, it is envisaged that most commonly the system 40 will be used by a plurality of financial institutions.

Three components of the system 40 are provided by or at the bank 74: a secure bank gateway 76, a bank account management system 78 and a bank online site 80. (In some embodiments, secure provider gateway 70 and secure bank gateway 76 may be provided as a single gateway.) The system 40 also includes a secure data link 82 between secure provider gateway 70 and secure bank gateway 76; data links 84a and 84b are also provided between secure bank gateway 76 and bank account management system 78 and between bank account management system 78 and bank online site 80 respectively, internal to bank 74.

The secure data link 82 exchanges balance information in real- or quasi-real time between secure provider gateway 70 and secure bank gateway 76. The data “capsule” exchanged in this manner (in the case of a mobile telephony service provider) includes:
User ID
Account ID (BSB, Account Number)
Sub-account ID 1 to x (if sub-accounts are used)
Host service provider ID (e.g. carrier)
Host service provider access key (real time encryption)
Current balance (a positive or negative value)
Balance credit/debit flag
Credit limit
Credit limit reached flag
Current activity associated with current transaction (e.g. length of current call)
Transaction type (3 digit code)
Transaction date stamp (dd/mm/yyyy)
Transaction time stamp (hh:mm:ss; hh in 24 hours format)
Transaction description (finite length text field e.g. “off peak Service Provider X mobile to Network Y mobile call”)
Transaction usage (e.g. 300 seconds, or 1 sms of less than 120 characters)
Transaction amount ($)

The Account ID is important not only to ensure that an account of the customer is used, but also to ensure that the correct account of the customer is used. A particular customer may have a plurality of accounts, arranged to provide the functionality of this embodiment. A customer may, for example, have a separate account corresponding to the provision of a specific product (such as voice telephony, SMS, MMS and GPRS). By this technique, the customer's expenditure on each product can be separately limited or managed.

In a variation of this approach, however, a single account may comprise a plurality of sub-accounts, if bank 74 or the service provider permits a customer's account to be organized in that manner. Each sub-account then corresponds to the provision of a specific product, typically—though not necessarily—provided by the same service provider. For any particular account, each sub-account has a different Sub-account ID, so that charges corresponding to a specific product type can be assigned to the correct sub-account. For this reason the data capsule optionally includes a Sub-account ID, indicative of the appropriate sub-account.

From the customer's perspective, a plurality of such sub-accounts is functionally little if at all different from a plurality of essentially conventional but linked accounts, with the group of linked accounts assigned an Account group ID or the individual accounts otherwise identified as being so linked (such as by have Account IDs that share a common prefix). In such instances, the Account group ID or common prefix and the individual Account IDs become the equivalent of the Account ID and Sub-account IDs of the previous arrangement, respectively, and the user need not be aware of or concerned about such distinctions.

However, the bank account—when inspected by the customer—may not display these distinct accounts or sub-accounts separately. These may be kept distinct by the service provider, but partially or fully aggregated by the bank 74 for simplicity or convenience.

The choice of arrangement (i.e. plural accounts, plural sub-accounts, or plural linked accounts) may thus be at the preference of bank 74. If chosen by the customer and implemented by the bank, the choice may in any event be influenced by a fee structure imposed by the bank for providing each of these arrangements.

Thus, aggregated, parsed, integrated and formatted data output by secure provider gateway 72 is forwarded securely to secure bank gateway 76, then passed to bank account management system 78. (In embodiments with multiple financial institutions, secure provider gateway 72 will communicate with their respective multiple financial institution secure gateways, though for any one transaction generally with the secure gateway of only one of those financial institutions.)

In order to explain the operation of the billing system 40, one can consider the simple example of a customer who wishes to establish a suitable arrangement for receiving and paying a new mobile telephony account, associated with the use a mobile telephone. Opening the mobile telephony account is comparable to opening a new bank account (whether savings, credit or otherwise) and is done at bank 74. The bank account management system 78 is configured to receive data ultimately from the secure provider gateway 70 indicative of a “transaction” (typically the use by a customer of a services provided by the utility provider such as, in this example, a telephone call or calls), and creates an entry in the customer's account.

The account is created like any other bank account. When the customer applies to open that account, he or she proves whatever identity documents are required by the bank or by law. If the customer is already a customer of that bank, the process may be simplified as the bank should already possess the customer's details, and the customer may not be required to present some or all of the usual identity documents. Once created, a corresponding account will in due course be created by the service provider account management and billing system 86a.

Funds can then be transferred into the account by any known technique, such as by depositing cash or a cheque in the bank, or electronically transferring funds to the account if the bank provides that facility. Commonly this may be done by means of the internet. The billing system 40 serves to couple the account of the customer to the use of the customer's mobile telephone. This is not done by settling the telephone account rendered by the telephony provider by extracting funds from the bank account, but rather by arranging the bank account and the telephone account to be synchronized and hence one; the system 40 ensures that the necessary information is exchanged between the rating and billing modules 50, 52, 54, 56, 58, 60 and the bank account management system 78 of the bank 74, which acts as the interface between the system 40 and the customer's bank (and hence, telephone) account—henceforth referred to as the “account”.

The billing system 40 thus avoids the crossing of organisational boundaries during bill payment, thereby improving transaction security.

Hence, transferring funds into the account—such as by internet banking using the bank online site 80—is equivalent to financially “recharging” the telephone (if the customer's contract with the telephony provider is a “pre-paid” arrangement, that is, must be in surplus for the telephone to remain connected), or to paying an outstanding balance (if the contract permits billing after usage, sometimes referred to as a “post-paid” arrangement). In the former case, the account operates much like a savings account, while in the latter case like a credit card account. Conditions can be imposed on either type of account, particularly in the latter case, to protect the financial institution or telephony provider. Alternatively, the financial institution could permit the customer to have either a positive or negative balance in the account, corresponding to so-called converged or hybrid billing).

Furthermore, if the customer's account comprises a plurality of sub-accounts (as described above), separate conditions can be imposed—if desired—on each sub-account. For example, in a post-paid arrangement each sub-account may have its own credit limit, so that the customer, even if exhausting their access to one product (e.g. voice telephony), may still have access to another (e.g. SMS).

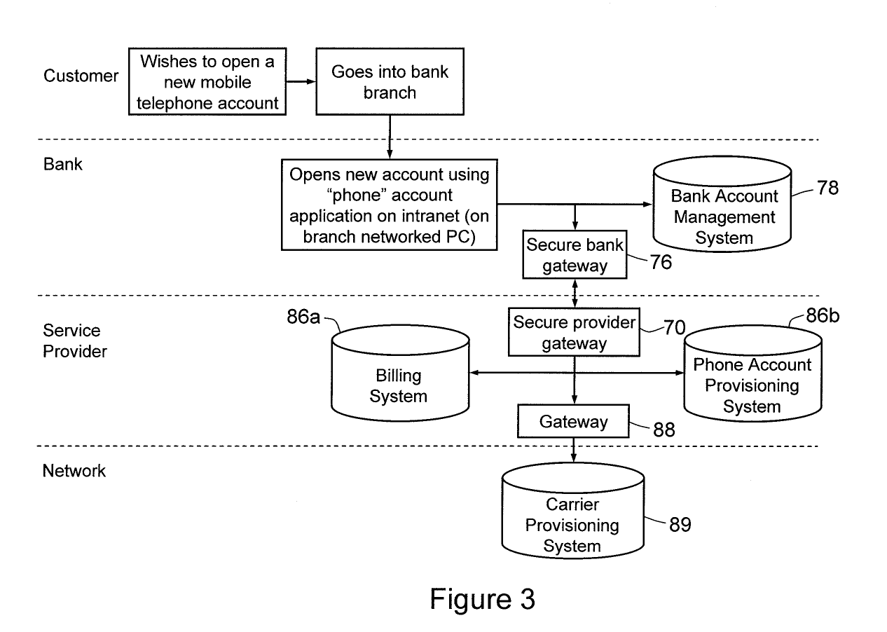

FIG. 3 is a schematic view of the steps employed by a customer in activating—in this example—a mobile telephony account at bank 74 according to this embodiment. A customer who wishes to open a new mobile telephone account goes into a branch of the bank 74 and opens a new account using a “phone” account application on the bank's intranet (on a branch networked PC). The bank account management system 78 establishes a new account by standard bank processes. The secure bank gateway 76 sends the relevant account creation and provisioning data to the service provider via secure data link 82 and secure provider gateway 70, for forwarding within the service provider to, respectively, a service provider account management and billing system 86a and provisioning system 86b (to reserve necessary resources including a telephone number).

A further gateway 88 (which may in practice be secure provider gateway 70) sends relevant account creation service provisioning data to the network's service provisioning system 89 to reserve necessary resources (including the telephone number).

At each stage, confirmation messages are sent to previous parts of the activation chain but—for simplicity—are not shown in FIG. 3 It is envisaged that bank 74 will receive a commission from the telephony provider for its participation in the billing system 40, but this could alternatively be any other form of recompense including those currently levied by financial institutions on their customers (including annual charges and interest).

This transferring of funds into the account—as discussed above—is performed with the bank's existing infrastructure and billing presentation (or statement generating) layer infrastructure, as the bank account management system 78 and a bank online site 80 may be used in existing or only somewhat modified form. Typically the bank's telephone and internet banking systems will display the account and associated details (including transactions and balance) in the same manner as employed for other (e.g. savings, credit card, etc) accounts.

Note that the customer will be asked at the point of sale to decide whether they want to manage their expenditure in a single expenditure “bucket” or in multiple buckets, each corresponding to a particular service (e.g. voice, SMS, MMS, GPRS). This determines how the customer's account will be established on the relevant financial services and telecommunications service provider systems; if the latter option is selected, each product will be treated separately and assigned its own account or sub-account (as described above).

In this embodiment, funds cannot be transferred out of the account (though in other embodiments this might be permitted under certain conditions). This is because the account is intended principally to provide a mechanism for the customer to inspect their use of the services of the service provider (e.g. voice telephony, SMS, MMS, GPRS), and to pay for past or future use.

It will be appreciated that the billing system 40 —as illustrated in FIG. 2—can also be employed for utilities other than telephony, including electricity, gas and water. Indeed, in other embodiments, a billing system comparable to billing system 40 can be used by other providers of goods or services, such as providers of professional services or of goods (particularly by mail order or on-line). Furthermore, a customer may have multiple accounts of the type described above, one corresponding to each provider. Alternatively, in some embodiments the account can correspond to a plurality of providers; however, this can be distinguished from mere “bill aggregation” (whereby numerous transaction records from various services are collated and rendered on a single bill), as according to system 40 the account of an external service provider (e.g. a telephony provider) is established within the systems of a financial services institution.

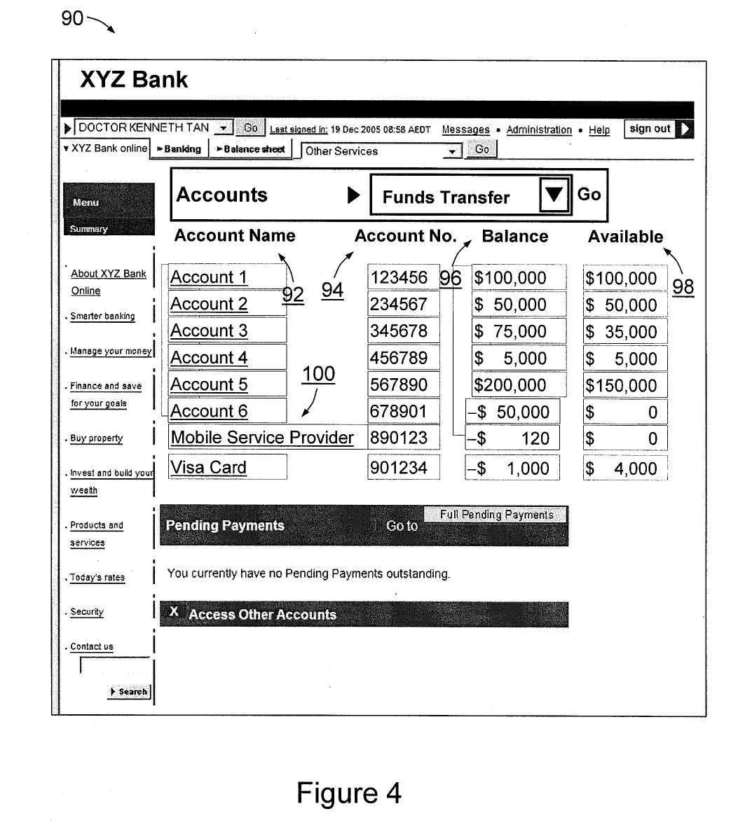

As discussed above, according to system 40 a customer with an internet banking arrangement with bank 74 can inspect the account in the same manner in which the customer would inspect any other account. FIG. 4 is a view of the customer user interface 90 of billing system 40; it is also the internet banking interface of bank 40 and is viewed at bank online site 80 (identified in FIG. 4 as “XYZ Bank”). In FIG. 4, the interface is shown displaying the view obtained when the customer requests (by operation of the appropriate menu) that account details be displayed, including account names 92, account numbers 94, balances 96 and available funds 98. The account appears as account “Mobile Service Provider” 100 (in this example with account number 890123) and shows a balance of −$120. This means that the customer has spent $120 on telephone calls using a post-paid account. The “available” funds are $0, because account 100 has a spending cap of $120, and that cap has been reached.

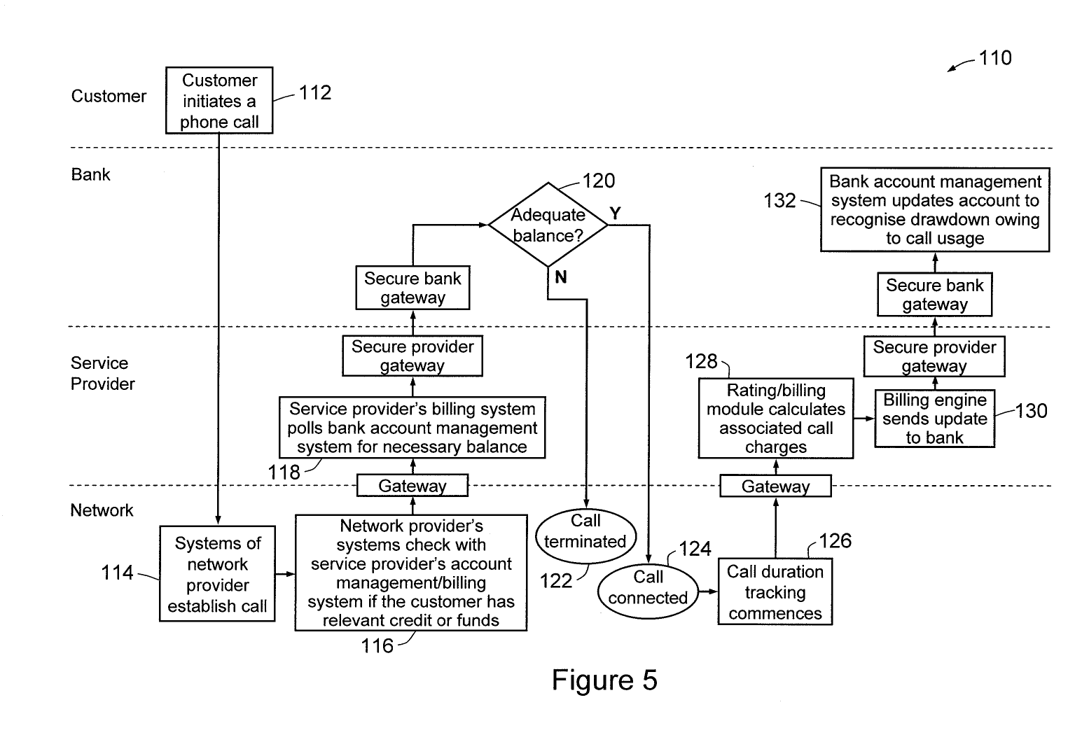

Although the emphasis in the above description has been on the manner in which system 40 passes billing information to the account of the customer, and the manner in which the customer can view and transfer funds into the account, the system 40 also permits the utility or service provider to poll the bank account management system 78 to determine whether a transaction requested by the customer (such as an attempt to make a telephone call) should be allowed on the basis of available credit or funds. Thus, as mentioned above, secure data link 82 exchanges balance information in both directions. This is illustrated in more detail in FIG. 5, which is a flowchart 110 of real-time user customer call usage measurement according to the system 40 of FIG. 2, using the mobile telephony example.

At step 112, the customer initiates a phone call. At step 114, the systems of the network provider establish a call then, at step 116, the network provider's systems check with service provider's account management/billing system 86a whether the customer has the required credit or funds for the requested call.

At step 118, the service provider's billing system 86a polls the bank account management system 78 for the relevant necessary balance (such as of account 100 in FIG. 4). As will be appreciated by those skilled in the art, the polling may merely confirm that the information concerning the account balance most recently obtained by the service provider's billing system 86a is correct. At step 120, the bank determines whether an adequate balance exists or not. If not, the call is terminated at step 122.

This polling (and hence consequent synchronization) thus occurs essentially in real-time or close to real-time. This prevents revenue leakage (which is particularly relevant in the provision of mobile telephony services); when a customer makes calls that draw down on his or her account balance, the telecommunications service provider and the financial services institution to which the telecommunications service provider synchronizes accounts, usage, transaction and financial information seeks to ensure that the customer does not consume more services than is allowed by the balances in the relevant accounts.

For example, customer with a prepaid mobile telephone may have an account balance synchronised between the telecommunications service provider's billing system and the financial institution's transaction management system. (The financial institution account may be regarded as an alias to the telecommunications service provider's account, or vice versa). This enables the customer to readily access, settle, or top-up his or her account with Internet Banking provided from his or her bank, without to incurring merchant fees that might be imposed if settling the telecommunications bill at or through a non-synchronized bank account.

If an adequate balance does exist, processing continues at step 124 where the call is connected. At step 126, call duration tracking commences. When the call is completed (or at periodic intervals), the mobile phone service provider rating and billing module 50 calculates (at step 128) the associated call charges, then at step 130 sends the resulting data capsule to bank 74. At step 132 the bank account management system 78 updates the account 100 to reflect the drawdown due to the call usage.

It should be noted that this embodiment can also operate “in reverse”, in that the customer account could be established in the financial services provider's transaction management system and the appropriate synchronisation back to the telecommunications service provider's or utility's billing and rating system be implemented to result in the same user interfaces. It is largely immaterial whether the account maintained by the financial institution is regarded as primary and that maintained by the service provider (and synchronized to the account maintained by the financial institution) as a mere alias thereof, or vice versa.

In view of the above description, one can realize numerous embodiments. In a first aspect, therefore, the invention provides a billing system in which the billing account of a service (or other) provider is created as an account alias within a financial institution (such as a bank), or vice versa, so that the service provider's account (viz. bill) appears as would an account of the financial institution and can be paid by the customer's transferring funds into the account of the financial institution.

In one broad aspect, the invention provides a billing system, comprising:

a service provider account management system configured to maintain at least one service provider account for a customer;

a financial institution account management system configured to maintain at least one financial institution account for the customer; and

a gateway in data communication with the service provider account management system and the financial institution account management system, configured to exchange account data between the service provider account management system and the financial institution account management system;

wherein the account data is adapted to allow the service provider account management system and the financial institution account management system to synchronize the service provider account and the financial institution account, and the service provider account management system and the financial institution account management system are arranged to update the service provider account and the financial institution account respectively according to the account data.

The service provider account management system may be adapted to receive data indicative of a service provision to a customer, to determine a charge corresponding to the service provision, and to output billing data indicative of the customer and of the charge.

In one embodiment, the account management system or the gateway is adapted to respond to a request from the financial institution account management system for service provider account data by returning service provider account data.

In another embodiment, the financial institution account management system or the gateway is adapted to respond to a request from the service provider account management system for financial institution account data by returning financial institution account data.

The service provider account management system may comprise a service provider billing module and the billing data includes usage data.

The financial institution account management system may be arranged to respond to a depositing of funds into the financial institution account by transmitting deposit data to the service provider account management system, and the service provider account management system is adapted to respond to receiving the deposit data by updating the service provider account.

In one embodiment, the service provider account is one of a plurality of service provider accounts for the customer or comprises a plurality of service provider sub-accounts, and the account data is adapted to allow the service provider account management system and the financial institution account management system to synchronize the service provider accounts or sub-accounts with the financial institution account.

In one embodiment, the financial institution account is one of a plurality of financial institution accounts for the customer or comprises a plurality of financial institution sub-accounts, and the account data is adapted to allow the service provider account management system and the financial institution account management system to synchronize the financial institution accounts or sub-accounts with the service provider account.

In these two embodiments (which may be combined), each of the accounts or sub-accounts may correspond to a respective different service.

In one embodiment, the service provision comprises provision of telephony services.

In a particular embodiment, the system further includes the service provider account management system, wherein the financial institution account management system is arranged to respond to a depositing of funds into the financial institution account by transmitting deposit data to the service provider account management system, and the service provider account management system is adapted to respond to receiving the deposit data by updating the service provider account (typically by updating an associated account balance).

In another broad aspect, the invention provides a billing system, comprising:

a service provider account management system configured to receive data indicative of a service provision to a customer, for determining a charge corresponding to the service provision, outputting billing data indicative of the customer and of the charge, and maintaining at least one service provider account for the customer; and

a gateway in data communication with the service provider account management system, configured to receive the billing data, to prepare service provider account data from the billing data, and to direct the service provider account data to a financial institution account management system;

wherein the gateway is operable to be in electronic data communication with the financial institution account management system, the service provider account data is adapted to be receivable by the financial institution account management system and to control or prompt the financial institution account management system to modify at least one financial institution account of the customer to include information indicative of the charge, and the service provider account management system is adapted to receive financial institution account data from the financial institution account management system indicative of deposits to or withdrawals from the financial institution account, so that the financial institution account and the service provider account can be synchronized, whereby the customer can ascertain information about the service provider account by inspecting the financial institution account.

The service provider account management system may be adapted to receive data indicative of a service provision to a customer, to determine a charge corresponding to the service provision and to output billing data indicative of the customer and of the charge.

The service provider account management system may comprise a service provider billing module and the billing data includes usage data.

The service provision may comprise provision of telephony services.

The system may further include the financial institution account management system, wherein the financial institution account management system is arranged to respond to a depositing of funds into the financial institution account by transmitting deposit data to the service provider account management system, and the service provider account management system is adapted to respond to receiving the deposit data by updating the service provider account. In this embodiment, the financial institution account may correspond to a plurality of service provider accounts, or to a service provider account that comprises a plurality of service provider sub-accounts, each of the service provider accounts or service provider sub-accounts corresponding to respective different services.

The system may be operable to impose an expenditure limit on the service provider account or on one or more of the sub-accounts.

In one embodiment, the service provider is a telecommunications provider, and the billing system is operable to impose an expenditure limit on the account (or, where the account has a plurality of sub-accounts, on one or more of the sub-accounts). It is thereby possible to limit the expenditure of a customer or of a customer on one or more specific products.

The financial institution account of the customer may be a savings account or a credit card account held by the financial institution.

According to another broad aspect, there is provided a billing interface system, comprising:

a financial institution account database containing at least one financial institution account of a customer; and

a financial institution account management system configured to maintain the financial institution account, adapted to receive account data relating to the customer from at least one service provider and to respond thereto by modifying the financial institution account to reflect the account data, such that the financial institution account is synchronized with at least one corresponding service provider account maintained by the service provider, so that the customer can ascertain information about the service provider account by inspecting the financial institution account.

According still another aspect, the invention provides a method of managing at least one service provider account of a customer, comprising:

maintaining the service provider account with a service provider account management system;

maintaining at least one financial institution account with a financial institution account management system; and

electronically synchronizing the service provider account and the financial institution account by electronically exchanging account data between the service provider account management system and the financial institution account.

The method may include exchanging account data between the service provider account management system and the financial institution account via a gateway.

The method may include imposing a credit limit on the service provider account.

The method may include constraining the financial institution account to accept deposits only, whereby any withdrawals in the financial institution account are due to synchronization with the service provider account.

The method may include the service provider account management system determining a charge corresponding to a service provision, preparing billing data indicative of the customer and of the charge, preparing the account data from the billing data, and electronically forwarding the account data to the financial institution account management system.

In another broad aspect, the invention provides a billing or accounting system, comprising:

a first vendor account management system configured to maintain at least one first vendor account for the customer; and

a second vendor account management system configured to maintain at least one second vendor account for the customer;

a gateway in data communication with the first vendor account management system and the second vendor account management system, configured to exchange account data between the first vendor account management system and the second vendor account management system;

wherein the account data is adapted to allow the first vendor account management system and the second vendor account management system to synchronize the first vendor account and the second vendor account, and the first vendor account management system and the second vendor account management system are arranged to update the first vendor account and the second vendor account respectively according to the account data.

In one embodiment, one of the first and second vendors is a service provider and the other of the first and second vendors is a financial institution.

In one embodiment, the first vendor account is one of a plurality of first vendor accounts for the customer or comprises a plurality of first vendor sub-accounts, and the account data is adapted to allow the first vendor account management system and the second vendor account management system to synchronize the first vendor accounts or sub-accounts with the second vendor account.

In an embodiment, the second vendor account is one of a plurality of second vendor accounts for the customer or comprises a plurality of second vendor sub-accounts, and the account data is adapted to allow the first vendor account management system and the second vendor account management system to synchronize the second vendor accounts or sub-accounts with the first vendor account.

In another broad aspect, the invention provides an account data packet or packets adapted to control or prompt an account management system of a financial institution to modify at least one account of a customer to reflect a charge derived from data indicative of service provision, so that the financial institution account can mirror at least one corresponding service provider account.

In still another broad aspect, the invention provides an account data packet or packets adapted to control or prompt an account management system of a first service provider to modify at least one account of a customer to be synchronized to a second service provider.

In one embodiment, one of the first and second service providers is a financial institution.

Modifications within the scope of the invention may be readily effected by those skilled in the art. It is to be understood, therefore, that this invention is not limited to the particular embodiments described by way of example hereinabove.

In the claims that follow and in the preceding description of the invention, except where the context requires otherwise owing to express language or necessary implication, the word “comprise” or variations such as “comprises” or “comprising” is used in an inclusive sense, i.e. to specify the presence of the stated features but not to preclude the presence or addition of further features in various embodiments of the invention.

Further, any reference herein to prior art is not intended to imply that such prior art forms or formed a part of the common general knowledge.

1. A billing system, comprising:
a service provider account management system configured to maintain at least one service provider account for a customer;
a financial institution account management system configured to maintain at least one financial institution account for said customer; and
a gateway in data communication with said service provider account management system and said financial institution account management system, configured to exchange account data between said service provider account management system and said financial institution account management system;
wherein said account data is adapted to allow said service provider account management system and said financial institution account management system to synchronize said service provider account and said financial institution account, and said service provider account management system and said financial institution account management system are arranged to update said service provider account and said financial institution account respectively according to said account data.

2. The billing system as claimed in claim 1, wherein said service provider account management system is adapted to receive data indicative of a service provision to a customer, to determine a charge corresponding to said service provision, and to output billing data indicative of said customer and of said charge.

3. The billing system as claimed in claim 1, wherein said service provider account management system or said gateway is adapted to respond to a request from said financial institution account management system for service provider account data by returning service provider account data.

4. The billing system as claimed in claim 1, wherein said financial institution account management system or said gateway is adapted to respond to a request from said service provider account management system for financial institution account data by returning financial institution account data.

5. The billing system as claimed in claim 1, wherein said service provider account management system comprises a service provider billing module and said billing data includes usage data.

6. The billing system as claimed in claim 1, wherein said financial institution account management system is arranged to respond to a depositing of funds into said financial institution account by transmitting deposit data to said service provider account management system, and said service provider account management system is adapted to respond to receiving said deposit data by updating said service provider account.

7. The billing system as claimed in claim 1, wherein said service provider account is one of a plurality of service provider accounts for said customer or comprises a plurality of service provider sub-accounts, and said account data is adapted to allow said service provider account management system and said financial institution account management system to synchronize said service provider accounts or sub-accounts with said financial institution account.

8. The billing system as claimed in claim 7, wherein each of said service provider accounts or service provider sub-accounts corresponds to a respective different service.

9. The billing system as claimed in claim 1, wherein said financial institution account is one of a plurality of financial institution accounts for said customer or comprises a plurality of financial institution sub-accounts, and said account data is adapted to allow said service provider account management system and said financial institution account management system to synchronize said financial institution accounts or sub-accounts with said service provider account.

10. The billing system as claimed in claim 9, wherein each of said financial institution accounts or financial institution sub-accounts corresponds to a respective different service.

11. A billing system, comprising:
a service provider account management system configured to receive data indicative of a service provision to a customer, to determine a charge corresponding to said service provision, to output billing data indicative of said customer and of said charge, and to maintain at least one service provider account for said customer; and
a gateway in data communication with said service provider account management system, configured to receive said billing data, to prepare service provider account data from said billing data, and to direct said service provider account data to a financial institution account management system;
wherein said gateway is operable to be in electronic data communication with said financial institution account management system, said service provider account data is adapted to be receivable by said financial institution account management system and to control or prompt said financial institution account management system to modify at least one financial institution account of said customer to include information indicative of said charge, and said service provider account management system is adapted to receive financial institution account data from said financial institution account management system indicative of deposits to or withdrawals from said financial institution account, so that said financial institution account and said service provider account can be synchronized, whereby said customer can ascertain information about said service provider account by inspecting said financial institution account.

12. The billing system as claimed in claim 11, wherein said service provider account management system is adapted to receive data indicative of a service provision to a customer, to determine a charge corresponding to said service provision and to output billing data indicative of said customer and of said charge.

13. The billing system as claimed in claim 12, wherein said service provider account management system comprises a service provider billing module and said billing data includes usage data.

14. The billing system as claimed in claim 11, wherein said service provision comprises provision of telephony services.

15. The billing system as claimed in claim 11, further including said financial institution account management system, wherein said financial institution account management system is arranged to respond to a depositing of funds into said financial institution account by transmitting deposit data to said service provider account management system, and said service provider account management system is adapted to respond to receiving said deposit data by updating said service provider account.

16. The billing system as claimed in claim 11, wherein said financial institution account corresponds to a plurality of service provider accounts, or to a service provider account that comprises a plurality of service provider sub-accounts, each of said service provider accounts or service provider sub-accounts corresponding to respective different services.

17. The billing system as claimed in claim 11, operable to impose an expenditure limit on said service provider account or on one or more of said sub-accounts.

18. The billing system as claimed in claim 11, wherein said data is adapted to control or prompt said account management system to modify said financial institution account to include information indicative of said charge and of said service provision.

19. The billing system as claimed in claim 11, wherein said financial institution account of said customer is a savings account or a credit card account held by said financial institution.

20. A billing interface system, comprising:
a financial institution account database containing at least one financial institution account of a customer; and
a financial institution account management system configured to maintain said financial institution account, to receive account data relating to said customer from at least one service provider and to respond thereto by modifying said financial institution account to reflect said account data, such that said financial institution account is synchronized with at least one corresponding service provider account maintained by said service provider, so that said customer can ascertain information about said service provider account by inspecting said financial institution account.

21. A method of managing at least one service provider account of a customer, comprising:
maintaining said service provider account with a service provider account management system;
maintaining at least one financial institution account with a financial institution account management system; and
electronically synchronizing said service provider account and said financial institution account by electronically exchanging account data between said service provider account management system and said financial institution account.

22. The method as claimed in claim 21, further comprising exchanging account data between said service provider account management system and said financial institution account via a gateway.

23. The method as claimed in claim 21, further comprising imposing a credit limit on said service provider account.

24. The method as claimed in claim 21, further comprising constraining said financial institution account to accept deposits only, whereby any withdrawals in said financial institution account are due to synchronization with said service provider account.

25. The method as claimed in claim 21, further comprising said service provider account management system determining a charge corresponding to a service provision, preparing billing data indicative of said customer and of said charge, preparing said account data from said billing data, and electronically forwarding said account data to said financial institution account management system.

26. A billing or accounting system, comprising:
a first vendor account management system configured to maintain at least one first vendor account for said customer;
a second vendor account management system configured to maintain at least one second vendor account for said customer; and
a gateway in data communication with said first vendor account management system and said second vendor account management system, configured to exchange account data between said first vendor account management system and said second vendor account management system;
wherein said account data is adapted to allow said first vendor account management system and said second vendor account management system to synchronize said first vendor account and said second vendor account, and said first vendor account management system and said second vendor account management system are arranged to update said first vendor account and said second vendor account respectively according to said account data.

27. The system as claimed in claim 26, wherein one of said first and second vendors is a service provider and the other of said first and second vendors is a financial institution.

28. The system as claimed in claim 26, wherein said first vendor account is one of a plurality of first vendor accounts for said customer or comprises a plurality of first vendor sub-accounts, and said account data is adapted to allow said first vendor account management system and said second vendor account management system to synchronize said first vendor accounts or sub-accounts with said second vendor account.

29. The system as claimed in claim 26, wherein said second vendor account is one of a plurality of second vendor accounts for said customer or comprises a plurality of second vendor sub-accounts, and said account data is adapted to allow said first vendor account management system and said second vendor account management system to synchronize said second vendor accounts or sub-accounts with said first vendor account.

30. An account data packet or packets adapted to control or prompt an account management system of a financial institution to modify at least one account of a customer to reflect a charge derived from data indicative of a service provision, so that said financial institution account can mirror at least one corresponding service provider account.

31. An account data packet or packets adapted to control or prompt an account management system of a first service provider to modify at least one account of a customer to be synchronized to a second service provider.

32. The account data packet or packets as claimed in claim 31, wherein one of said first and second service providers is a financial institution.
